(19) United States
(12) Patent Application Publication
(10) Pub. No.: US 2016/0362309 A1
(43) Pub. Date: Dec. 15, 2016

(54) SYSTEMS AND METHODS FOR GEOTHERMAL ENERGY HARNESSING FROM WELLS FOR WATER TREATMENT

(71) Applicant: Amin Kiahghadi, Houston, TX (US)

(72) Inventor: Amin Kiahghadi, Houston, TX (US)

(73) Assignee: University of Houston System, Houston, TX (US)

(21) Appl. No.: 15/180,319

(22) Filed: Jun. 13, 2016

Related U.S. Application Data
(60) Provisional application No. 62/174,966, filed on Jun. 12, 2015.

(51) Int. Cl. C02F 1/44; C02F 5/06; B01D 61/36; B01D 1/00; B01D 1/28; C02F 1/24; C02F 1/50; C02F 1/04

(52) U.S. Cl. CPC C02F 1/441; C02F 1/50; C02F 5/06; C02F 1/041; B01D 1/0047; B01D 1/28; C02F 1/24; B01D 61/364; C02F 2101/32

(57) ABSTRACT

Systems and methods discussed herein may harness geothermal energy from geothermal wells, such as a retrofitted decommissioned well, that may be utilized for water desalination. Hot fluids extracted from the geothermal well may be utilized to generate geothermal energy that can be utilized to power desalination devices to removal minerals and/or salt from produced water from another well. These hot fluids may be recirculated back into the geothermal well to gather heat and to form a closed-looped system that provides thermal energy to the desalination unit. The treated water may be stored for latter agricultural, municipal, and/or other use, or it may be utilized further hydraulic fracturing.

### RELATED APPLICATIONS

This application claims the benefit of U.S. Provisional Patent Application No. 62/174,966 filed on Jun. 12, 2015, which is incorporated herein by reference.

### FIELD OF THE INVENTION

This invention relates to harnessing geothermal energy from wells. More particularly, to provide power to desalination units.

### BACKGROUND OF INVENTION

Oil and gas are necessity for energy self-sufficiency. Presently, the process of hydraulic fracturing, or injecting large volumes of fracturing fluid (e.g. water, sand, chemicals, etc.) at extremely high pressures, can only extract oil and gas along with copious amounts of wastewater. Hydraulic fracturing wells produce a combination of oil, gas, flowback water and produced water from the formation. The volume of formation water is significantly greater than that of flowback water. In addition, conventional oil and gas wells also produce significant amount of produced water.

Upon completion of hydraulic fracturing, the fluid is allowed to flow back to relieve the downhole pressure and allow oil and gas migration to the surface. The term flowback water refers to the fracturing fluid mixed with formation brine flowing at a high flow rate immediately following hydraulic fracturing and before the well is placed into production. Flowback water is a transitory water challenge, lasting only for a short period of time for a given well and influenced by drilling rates, and it is only an issue for fracked wells. Produced water, on the other hand, refers to the fluid that continues to be coproduced with the oil and gas once the well is placed into production and may be present over the lifetime of the well. The general composition of produced water from conventional wells, fracked wells, or other type of wells includes dissolved and dispersed oil components, dissolved formation minerals, production chemicals, dissolved gases, and produced solids. Produced water can be considered as the largest by-product generated during oil and gas production operations.

Produced water clearly represents a more lasting challenge as water volumes and production periods are greater and generation of produced water is dependent of production stage. Options for handling produced water include disposal, treatment, and discharge. For example, these options may include deep well injection, discharge into surface waterbodies and groundwater, or using evaporation ponds. However, these approaches have contamination risks, geology limitations, may be prohibited in areas prone to earthquakes, can be cumbersome, require large area, or unlikely due to high concentration of undesirable impurities. Membrane and distillation technologies provide the highest quality water treatment, but disposal is currently favored since it is the most cost effective option for dealing with large volumes of high salinity produced water. Energy requirements for both technologies are the biggest obstacle to reducing treatment costs.

By harnessing geothermal energy from decommissioned wells, abandoned wells, low production wells, soon-to-be-shutdown wells, or the like, which is green, steady, relatively cheap, and independent of environmental and economic fluctuations, the cost of produced water treatment can become competitive with disposal.

### SUMMARY OF INVENTION

In one embodiment, systems and methods for geothermal energy harness from wells for water treatment. Working fluid may be cycled through a geothermal well and hot working fluid extracted from a geothermal well may utilized to provide thermal energy that may be utilized by treatment/desalination facilities, such as to removal minerals and/or salt from produced water received by the treatment/desalination facilities. In some embodiments, the produced water can be mixed with other contaminated waters prior to treatment and/or other contaminated water may be treated. These working fluids may be subsequently provided to an optional tank after the heat is harvested and utilized to power the treatment/desalination unit, at which point the working fluid is cool and may be cycled into the geothermal well again. The optional tank may allow additives (e.g. anti-bacterial, anti-corrosive, etc.) to be added and a pressure head to be built up for injection into the well. In some embodiments, these hot fluids may be circulated into and out of the well in a closed loop. By supplying the energy required for treatment by harnessing thermal energy from the well, the facility can efficiently deliver treated water (or the produced water after treatment/desalination), which may be stored for latter agricultural, industrial, municipal, and/or other uses, depending on the demand and the quality of treated water. The process may result in concentrated brine, but at a much lower volume that the produced water/contaminated water processes by the system. The concentrated brine can be disposed of utilizing any suitable disposal method if necessary or it can be used for other purposes like crystallization and/or recovery of toxic or precious/rare metals.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 is an illustrative example of an exemplary model for a produced and flowback water cycle;

FIG. 2 shows a schematic diagram of an improved system and method for treating produced water;

FIG. 3 shows a schematic diagram of a geothermal well;

FIG. 4 shows an example of a membrane system;

FIG. 5 shows a general example of a thermal desalination method; and

FIG. 6 is an illustrative embodiment of a VCD system.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

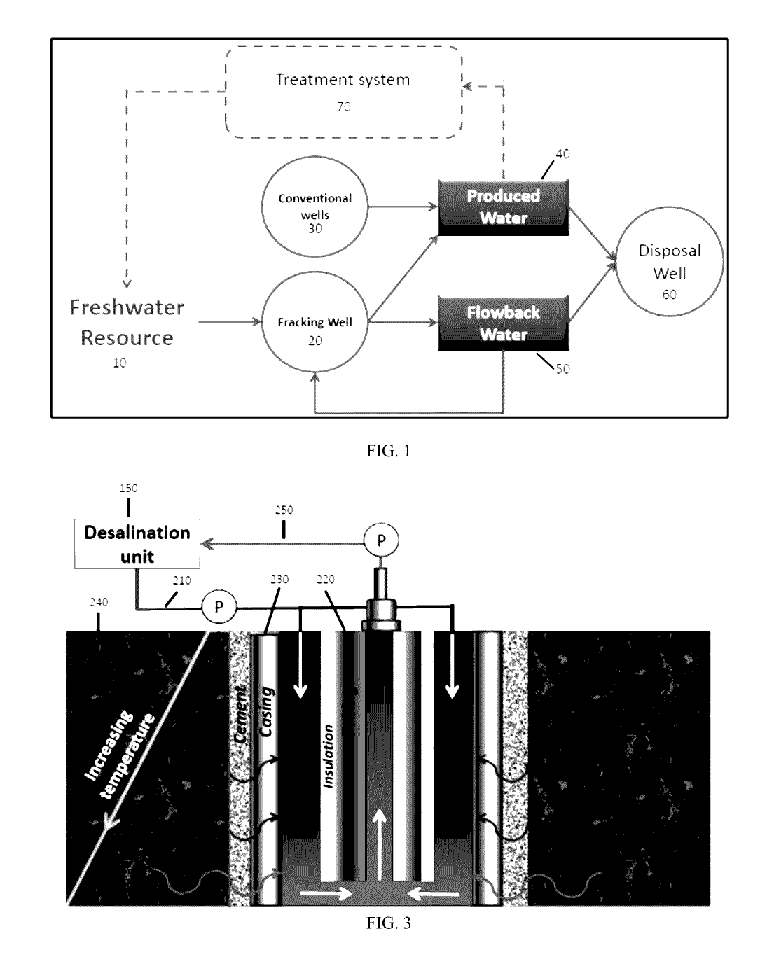

Systems and methods discussed further herein reclaim contaminated water using geothermal energy to power advanced desalination technologies (FIG. 1) thereby improving the economics of treatment when compared to other options. Contaminated water generally refers to any water containing undesirable pollutants or contaminants, which may be naturally occurring or may result from drilling, production, or any other procedures involved for a well. The nonlimiting examples discussed herein may discuss specific examples of contaminated water, such as flowback water or produced water for the purposes of illustration, but the systems and methods discussed herein may be applicable to treatment of any type of contaminated water. Conventional wells and fracking wells may produce a combination of oil, gas, flowback water, and/or produced water from the formation. The produced water is a lasting challenge and byproduct of wells that includes oil components, formation minerals, production chemicals, dissolved gases, and/or dissolved solids. Not surprisingly, it is desirable to treat produced water to remove as much of these undesirable compounds as possible. If a portion of the produced water generated by a well can be treated to acceptable quality or freshwater standards, a new source of water can be introduced for the region. The energy demands of some treatment options have been a major hurdle to prior treatment options. However, the systems and methods discussed herein harness a readily available and sustainable energy source with existing oil and gas infrastructure to overcome such issues. Additionally, there are some indirect benefits from these systems and methods as well, such as lowering the number of water trucks from the roads, which consequently reduces CO₂ emissions and accidents; utilizing a renewable energy source; increasing road lifetime; introducing new sources of water; and other benefits as well.

The paradigm shift in the improved systems and methods is to treat the contaminated water (e.g. produced water, flowback water, or other contaminated water) and reuse the resulting freshwater for agricultural, non potable municipal and/or other purposes. As show in FIG. 1, freshwater 10 is provided to a fracking well 20 that subsequently produces Produced Water 40 and/or Flowback Water 50. In some embodiments, Produced water 40 can also be produced from conventional wells 30. In some embodiments, the Flowback Water 50 may return to another fracking well or be sent to disposal well 60. The Produced Water 40 may be subjected to treatment by the treatment systems 70 and methods discussed further herein to provide fresh water. In cases where the Produced Water 40 cannot be treated using the treatment system 70, it may be sent to the disposal well 60 or sent for other disposal, treatment, and discharge approaches. The improved systems and methods are focused on keeping the technology green, thereby reducing CO₂ emissions and associated environmental risks. While the example discussed above notes a fracking well, it shall be noted that the applicability of the improved systems and methods are not limited to fracking wells. Further, while treatment of Produced Water 40 is discussed for illustrative purposes, any contaminated water (e.g. flowback or other contaminated water) may be treated by treatment system 70. The improved systems and methods may be utilized with any suitable wells where fresh water is desired, such as, but not limited to, convention wells, decommissioned wells, or the like. In a preferred embodiment, the improved systems and methods can be utilized with decommissioned or low production wells. Use with a decommissioned well, abandoned well, soon-to-be-shutdown wells, or low production well avoids the need for drilling a new well for this system.

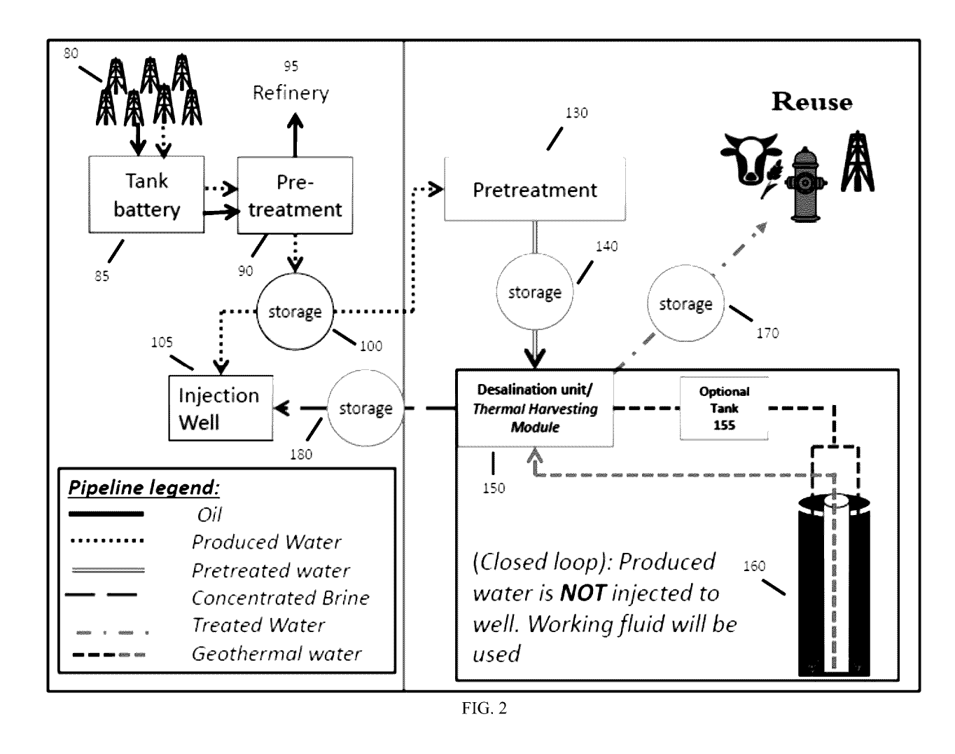

FIG. 2 show a schematic of a system and method for treating produced water from one or more wells. Notably, the left portion of the drawing is representative of prior processes, whereas the right portion represents the current systems and methods discussed herein. In some known methods, oil and produced water from well(s) 80 may be stored in storage or a tank battery 85 and separated by pre-treatment 90. The oil may be provided to refinery 95, and the produced water may be provided to storage 100 before being sent to a disposal or injection well 105. The left portion of the drawing is a nonlimiting example of prior processes, but is not the only method practiced.

Regarding the right portion of FIG. 2 representing the added features of current systems and methods, rather than disposing the produced water, the produced water is transferred to one of the treatment facilities for pretreatment 130 and may be subjected additional pretreatment and may be stored in storage 140.

The pretreatment unit 130 may remove unwanted oil or gas well byproducts, such as oil, gas, total suspended solids (TSS), insoluble organics, bacteria or the like, from the produced water. The pretreatment unit 130 may remove the unwanted byproducts of production from the produced water utilizing any suitable methods. The removal of such unwanted byproducts may prevent fouling and corrosion, which in turn increases the efficiency of the subsequent desalination process. As a nonlimiting example, TSS and bacteria removal may be achieved by settling/sedimentation systems using coagulants and flocculants, or filtration. As a nonlimiting example, disinfection options may include ozonation, chlorine dioxide generation and injection at the treatment site because there is minimal chemical transportation, and the process provides “bacteria-free” control. As a nonlimiting example, hardness can be removed via cold lime softening in which the lime is broken down and calcium carbonate is formed, which precipitates out and can therefore be removed easily. Finally, nonlimiting examples for the removal of oil and gas may be achieved through compact floatation. The pretreated water outputted from pretreatment unit 130 may have a reduced concentration of unwanted byproducts. However, significant salt or other minerals may still be present in the pretreated water outputted from the pretreatment unit 130. The pretreated water may then be provided to a treatment or desalination unit 150 to treat, remove salt and/or minerals and other contaminants from the water. The desalination unit 150 includes a thermal harvesting module that is capable of harvesting heat from the geothermal fluid or working fluid. The thermal energy required for the treatment of produced water is provided by repeatedly circulating working fluid through a geothermal well 160. In preferred embodiments, the geothermal well 160 may be decommissioned well that has been retrofitted for suitability as a geothermal well. The geothermal well may be referred to below as a retrofitted decommissioned well; however, it shall be understood that the geothermal well may be any suitable well as discussed previously above. For example, in other embodiments, the geothermal well 160 may be any other type of well, such as, but not limited to, an abandoned well, soon-to-be-shutdown wells, low production well, or in certain circumstances a new well. Working fluid may be water, any suitable fluid with high thermal conductivity, or a combination thereof to increase heat absorption from the geothermal well. In some embodiments, the geothermal well 160 may comprise multiple wells coupled to the treatment or desalination unit 150. After heat is harnessed from the working fluid by the treatment or desalination unit 150, the fluid may optionally be provided to a tank 155 for optional treatment of the working fluid, if desired. While the fluid is in the tank, additives may be provided. As a nonlimiting example, anti-corrosion or anti-bacterial materials may be added. Further, the tank may provide some of the pressure required to send the fluid back down the geothermal well through annulus between the casing and the retrofitted or new tubing. As the working fluid travels down the well, heat from the wall and bottom of the geothermal well is transferred to the fluid. The working fluid then travels up the central tubing, which may be isolated. This returning working fluid or hot working fluid from the well may then be provided to the desalination unit again to aid treatment of the produced water being received or any other contaminated water that can be treated by the desalination unit 150. It should be noted that the system for harnessing geothermal energy the geothermal well may form a closed looped system as the working fluid utilized to harness geothermal energy may be circulated repeatedly through the geothermal well, desalination unit (e.g. thermal harvesting module), and optionally the tank for optional treatment of the working fluid. In some embodiments, if the geothermal gradient is high and consequently the bottom hole temperature of the well is sufficient, part of the geothermal energy (or the heat from the working fluid) can be used for the treatment and the rest can be used to generate electricity for other uses or vice versa.

After treatment by the treatment or desalination unit, the now treated produced water may be provided to a storage unit 170 for latter agricultural, non-potable municipal, and/or other uses. The concentrated brine will be provided to a storage unit 180 where it can be recycled or may be later utilized for injection to the injection well 105, crystallized, and/or utilized for recovery of toxic, precious, or rare metals. The treated water quality would be dependent on the desalination technology and the final use. Thus, the total dissolved solid (TDS) concentrations could vary up to several orders of magnitude. It should also be noted that the contaminated water never enters the geothermal well 160, thereby avoiding potential scale or water loss problems.

FIG. 3 is an illustrative example of a geothermal well (e.g. 160 in FIG. 2). As shown, casing 230 is cemented in the formation 240, and tubing 220 is provided within the well. Cool working fluid 210 injected into an input of the geothermal well or the annulus between the tubing 220 and casing 230 flows downward through the annulus, and is gradually heated by the surrounding environment, such as formation 240, geology, casing, soil, or the like surrounding the cemented casing. When the injected working fluid reaches the bottom of the well, its direction is reversed, and the hot fluid 250 ascends to the output of the geothermal well or the tubing 220 and flows out to the surface or is extracted from the geothermal well. This extracted working fluid 250 has a higher temperature than when injected due to the heat absorption while traveling down the annulus. In contrast to standard steel or other types of tubing utilized in wells, the tubing 220 may be insulated to maximize retention of heat in the hot fluid 250 by minimizing or preventing unwanted heat transfer between the injected working fluid and hot working fluid, thereby allowing maximum energy to be harvested. As a nonlimiting example, thermal insulation provide on the inner surface, outer surface, and/or between well tubing layers/components. In some embodiments, it may be desirable to have an insulating layer provided for the casing up to a certain depth. This is for the cases in which the injected fluid has a higher temperature compared to the formation/casing up to that specific depth. By insulating the casing, the injected fluid will not lose heat by transfer to the formation/casing. The resulting hot working fluid outputted from the geothermal well will be routed a thermal harvesting module of the desalination unit 150. The thermal harvesting module may extract heat from the received hot working fluid to harvest energy, such as by using heat exchangers, turbines, generators, or the like. Such heat exchangers work based on the temperature differences between the hot working fluid and the produced/other contaminated waters. In embodiments using direct heating for thermal-based treatment purposes, where the technologies used in desalination unit allows, heat exchanger(s) transfer the heat from the working fluid circulating through the geothermal well to the produced/other contaminated waters from another well (e.g. conventional or fracking well) to allow the thermal-based desalination treatment to be performed. Further, in some embodiments, the working fluid may be routed through a heat exchanger coupled to a turbine and/or generator to generate electricity. In some embodiments, the generated electricity is utilized to power other equipment. It should also be recognized that the generated electricity can be utilized to open up other desalination options that require electricity. In further embodiments, a combination of the membrane and thermal-based desalination technologies may be utilized. As a nonlimiting example, if working fluid has enough heat to generate electricity first and then go through the heat exchanger to use the remain heat for thermal-based desalination, it is possible to use the electricity in the first stage for membrane technologies and the heat from the second part for thermal-based desalination. Membrane distillation technologies are currently growing, but such technologies require both electricity and heat. However, the use of generated electricity to power desalination may be less efficient, and may add additional equipment to the system, such as when electric power generation is unnecessary. As a result, the working fluid exiting the unit is cool or has a lower temperature than it did when entering the treatment/desalination unit, and may be re-injected into the geothermal well again. The thermal harvesting module may further provide a turbine and/or generator that are driven by the heat gathered from the hot fluid to generate electricity.

It is apparent from the discussion and illustrations that the system is a closed loop energy system. In some embodiments, this cold working fluid may be treated (e.g. optional tank) before re-injection into the geothermal well. This treatment may allow for basic treatment of the working fluid, such as, but not limited to, addition of anti-corrosion materials and anti-bacterial agents, may be performed to maintain working fluid performance. Further, a substantial pressure head may optionally be provided at this stage to compensate for the friction pressure drop during the injection of working fluid into the well. Hence, using the geothermal energy produced from the decommissioned wells, the desalination unit can readily be used to treat the produced water to provide clean water that can be used for latter agricultural, non-potable municipal, and/or other uses. In some cases, the treatment/desalination unit may produce brine, which can be disposed of by any suitable methods or it can be used for other purposes like crystallization and/or recovery of toxic or precious/rare metals. Such closed-looped embodiments may be particularly applicable to decommissioned wells, but other embodiments are not limited to use with decommissioned wells and may utilize any other type of well.

Total Dissolved Solids (TDS) Treatment Technologies: TDS treatment options that may be utilized as part of the abovementioned desalination unit 150 are discussed herein.

Pre-Treatment: Before produced water can be treated for TDS using suitable desalination technologies, it needs to be pre-treated for the removal of oil, total suspended solids (TSS), insoluble organics, and bacteria, to prevent fouling and corrosion, which in turn increases the efficiency of the subsequent distillation process. The technologies and processes used to remove these unfavorable components are presented below.

TSS and bacteria removal is achieved by settling/sedimentation systems using coagulants and flocculants, or filtration. For disinfection, options include ozonation, chlorine dioxide generation and injection of treatment materials at the treatment site. Hardness can be removed via cold lime softening, in which the lime is broken down and calcium carbonate is formed that precipitates out and can therefore be removed easily. Finally, the removal of oil and gas is achieved through compact floatation.

Membrane systems are typically more advantageous than thermal processes because they require lower energy consumption, lower capital cost, and have a smaller physical footprint. FIG. 4 shows an example of a membrane system. The contaminated or produced water after pre-treatment may be sent through a semi-permeable membrane, such as with an applied pressure, to filter out undesired materials and produce clean water. However, the downside is that membrane systems require pumps and electricity to power the pumps. Additionally, the feed water to membrane systems requires extensive pre-treatment (e.g. precipitants), additionally, membrane systems cannot be used for very high salinity water (for example: above seawater level of approximately 60,000-70,000 mg/L TDS). Hence, membrane processes will be largely ineffective in treating the high TDS (approximately 100,000 mg/L or more) water. Thus, while membrane systems are possible for the systems and methods discussed, other options may be preferred.

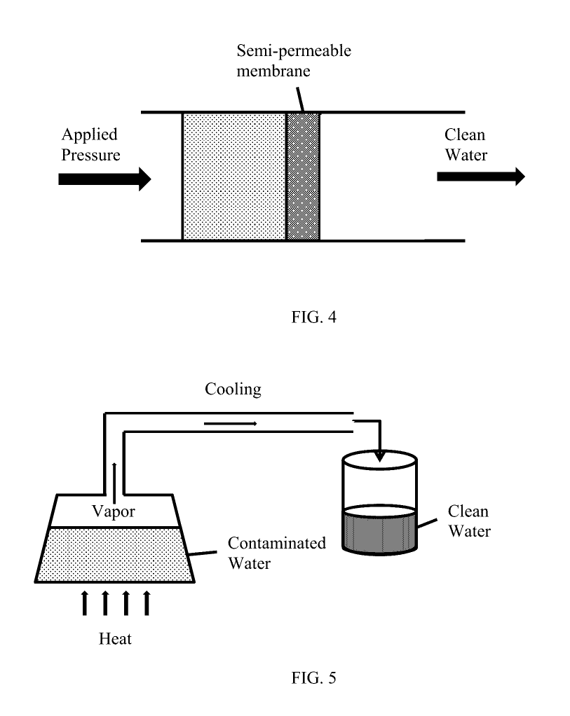

Recent innovations in materials and process engineering for thermal treatment methods have made thermal processes more attractive and financially competitive and have enabled the achievement of zero liquid discharge via treating highly contaminated water. FIG. 5 shows a general example of a thermal desalination method. The contaminated or produced water may be heated to a desired temperature that causes the water to vaporize, but does not cause the undesired dissolved solids to vaporize. The vaporized water may be routed through a cooling mechanism that allows the water to return to a liquid form without the undesired dissolved solids. Notably, in preferred embodiments, the heat applied to cause the contaminated or produced water to vaporize may be solely supplied from the heat harnessed from the geothermal well via the working fluid. In other embodiments, electricity generated by harnessing energy from the geothermal well may be utilized to generate the heat necessary to vaporize the contaminated or produced water. However, such embodiments may require additional equipment for the thermal harvesting module to convert the thermal energy to electric power. In further embodiments, the harnessed geothermal energy may be sufficient to both generate electricity and perform thermal-based desalination processes.

As mentioned previously, the extremely high TDS levels found in produced water favors the use of a thermal-based distillation process. Nonlimiting examples of suitable options include vapor compression distillation (VCD). VCD is particularly attractive as it can be efficiently run for smaller units (e.g. 1,100-18,000 barrels).

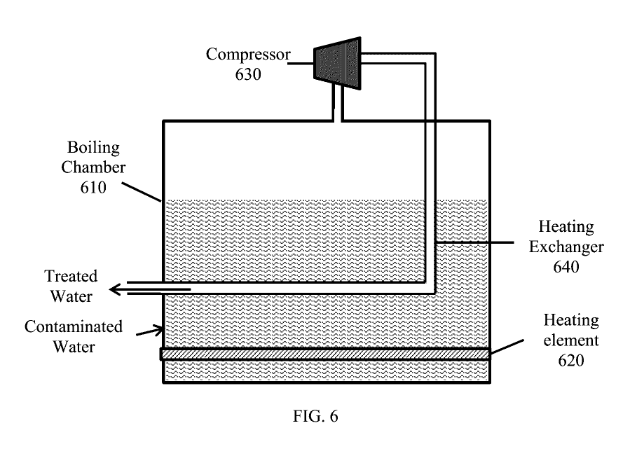

FIG. 6 is an illustrative nonlimiting embodiment of a VCD system. The water that is to be distilled or desalinated, such as the contaminated or produced water from an injection well, fracking well, or conventional well, may be fed to a boiling chamber 610 where a heating element 620 heats the water. In a traditional VCD system, the heating element 620 may be implemented electrically or with natural gas. However, in the systems discussed herein, the heating element 620 may be working fluid flowing through a heat exchanger to heat the contaminated or produced water. The vaporized water rises leaving behind the undesired impurities. The water vapor may be routed to an optional compressor 630 that compresses the water vapor, which is subsequently routed through a heat exchanger 640. As a result, the water vapor transfers heat to the produced water and the water vapor is cooled to return to a liquid form to form the treated water. Subsequently, the treated water is outputted to a desired location. In some embodiments, the compressor may be a high capacity compressor in the VCD allows for operation at low temperatures, below 70° C., thereby reducing the potential for scale formation and corrosion. The low operating temperatures also reduce the operating pressure. The variation in VCD depends on the method used to condense water vapor to produce sufficient heat to evaporate incoming water. Though VCD certainly has more benefits than the other distillation technologies, the recovery of permeate might be an issue, and needs to be adjusted to desired levels by recycling the brine into the feed water and increasing the level of treatment. Both low and high temperature geothermal reservoirs can be used to power thermal desalination technologies. The geothermal energy wells we propose can be classified as low temperature sources which will be used to run the evaporators in the VCD process or other thermal based technologies.

As noted previously, the treatment or desalination unit options discussed above may utilize any suitable treatment or desalination methods, such as thermal-based desalination or membrane distillation/desalination. Nonlimiting examples of suitable thermal-based desalination processes may include multi-stage flash (MSF), multi-effect evaporation (MEE)/multi-effect distillation (MED), vapor compression distillation (VCD), and solar desalination. Reverse osmosis (RO), membrane distillation, and electro-dialysis (ED) are nonlimiting examples of membrane separation processes.

Table 1 below illustrates the extracted flow temperature, energy per day, and amount of clean water that can be achieved. Based on additional simulations for various parts of Texas that considered well depths, TDS, geothermal gradients, the simulations showed a variety of different ranges treated water that can be produced. In some embodiments, the amount of treated water (gallons/day) may be 20,000 or greater. In some embodiments, the amount of treated water (gallons/day) may be 50,000 or greater. In some embodiments, the amount of treated water (gallons/day) may be 100,000 or greater. In some embodiments, the amount of treated water (gallons/day) may be 200,000 or greater. In some embodiments, the amount of treated water (gallons/day) may be 500,000 or greater.

TABLE 1

| | Extracted flow | Energy per day | Clean Water |
|---|---|---|---|
| Depth (ft) | temperature (° C.) | (KWh) | (gallon/day) |
| 10,000 | 76 | 7200 | 48,000 |
| 11,000 | 78 | 7510 | 50,000 |
| 12,000 | 80 | 7823 | 52,000 |
| 13,000 | 83 | 8292 | 55,000 |

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A method for harnessing geothermal energy for water treatment, the method comprising:
injecting working fluid into a geothermal well, wherein the working fluid is heated by a surrounding environment while traveling down the geothermal well;
extracting the working fluid from the geothermal well, wherein the working fluid has a higher temperature at extraction than injection;
supplying the working fluid extracted to a thermal harvesting module, wherein the thermal harvesting module harvest heat from the working fluid to harvest energy;
supplying contaminated water from an oil well or gas well;
pre-treating the contaminated water to remove unwanted byproducts of production; and
supplying the contaminated water after pre-treatment to a desalination unit, wherein the desalination unit removes salt or minerals from the contaminated water to output treated water, and the energy generated by the thermal harvesting module is utilized to power the desalination unit.

2. The method of claim 1, wherein the geothermal well is a decommissioned well, abandoned well, soon-to-be-shutdown well, or low production well.

3. The method of claim 1, wherein the geothermal well comprises a casing and tubing within the casing, wherein the tubing is insulated.

4. The method of claim 3, wherein the working fluid is injected into an annulus between the casing and the tubing, and extracted from the tubing.

5. The method of claim 4, wherein after the thermal harvesting module harvest the heat from the working fluid, the working fluid is re-injected into the geothermal well, and the working fluid is re-circulated in a closed loop.

6. The method of claim 1, wherein prior to injecting the working fluid, the working fluid is temporarily held in a tank where anti-corrosion materials or anti-bacterial agents are added.

7. The method of claim 1, wherein the treated water is output to storage.

8. The method of claim 1, wherein the working fluid supplied to the thermal harvesting module transfers the heat to the contaminated water for a thermal-based desalination method.

9. The method of claim 1, wherein the desalination unit is a vapor compression distillation (VCD) unit, multi-stage flash (MSF), multi-effect evaporation (MEE), multi-effect distillation (MED), or other thermal based technologies.

10. The method of claim 1, wherein the desalination unit is a membrane distillation, reverse osmosis (RO), or electro-dialysis (ED) unit.

11. The method of claim 1, wherein the treated water is utilized for agricultural or non-potable municipal use.

12. A geothermal energy water treatment system:
a working fluid injected into an input of a geothermal well, wherein the working fluid is heated by a surrounding environment while traveling down the geothermal well;
a thermal harvesting module coupled to an output of the geothermal well to receive the working fluid from the geothermal well, wherein the working fluid has a higher temperature at the output than the input, and the thermal harvesting module harvest heat from the working fluid to harvest energy;
a pre-treatment unit receiving contaminated water from an oil well or gas well, wherein remove unwanted byproducts of production are removed from the contaminated water in the pre-treatment unit; and
a desalination unit coupled to the pre-treatment unit, wherein the desalination unit removes salt or minerals from the contaminated water to output treated water, and the energy generated by the thermal harvesting module is utilized to power the desalination unit.

13. The system of claim 12, wherein the geothermal well is a decommissioned well, abandoned well, soon-to-be-shutdown well, or low production well.

14. The system of claim 12, wherein the geothermal well comprises a casing and tubing within the casing, wherein the tubing is insulated.

15. The system of claim 14, wherein the working fluid is injected into an annulus between the casing and the tubing, and extracted from the tubing.

16. The system of claim 15, wherein the working fluid is circulated in a closed loop.

17. The system of claim 12 further comprising a tank receiving the working fluid prior to injection into the geothermal well, wherein anti-corrosion materials or anti-bacterial agents are added to the tank.

18. The system of claim 12, wherein a storage unit receives the treated water.

19. The system of claim 12, wherein the thermal harvesting module comprises a heat exchanger, wherein further the working fluid received transfers the heat to the contaminated water for a thermal-based desalination method.

20. The system of claim 12, wherein the desalination unit is a vapor compression distillation (VCD) unit, multi-stage flash (MSF), multi-effect evaporation (MEE), multi-effect distillation (MED) , or other thermal based technologies.

21. The system of claim 12, wherein the desalination unit is a membrane distillation, reverse osmosis (RO), or electro-dialysis (ED) unit.

22. The system of claim 12, wherein the treated water is utilized for agricultural or non-potable municipal use.

23. The system of claim 12, wherein brine from the desalination unit is utilized for recycling, crystallized, or recovery of toxic, precious, or rare metals.
